(19) United States
(12) Patent Application Publication
(10) Pub. No.: US 2013/0333961 A1
(43) Pub. Date: Dec. 19, 2013

(54) MOTORIZED SHOPPING CART

(71) Applicant: THOMAS O'DONNELL, WARSAW, KY (US)

(72) Inventor: THOMAS O'DONNELL, WARSAW, KY (US)

(21) Appl. No.: 13/869,915

(22) Filed: Aug. 5, 2013

Related U.S. Application Data
(60) Provisional application No. 61/637,341, filed on Apr. 24, 2012.

(51) Int. Cl. B62B 5/00

(52) U.S. Cl. CPC B62B 5/0033
USPC 180/65.1

(57) ABSTRACT

The invention provides a shopping system for a wheelchair bound shopper comprising a wheelchair configured for use by the shopper, wherein the shopper is at least partially bound to the wheelchair and a motorized shopping cart for pulling itself and a wheelchair bound shopper in a store. The shopping cart comprises a base having a bottom side and a top side positioned oppositely to the bottom side of the base. At least three wheels are fixed to the underside of said base. Further provided is a basket attached to the top side of the base. The basket has a front, a back positioned oppositely to the front, and two sides positioned between the front and the back of the basket. A motor attached to at least one of the at least three wheels, the motor operating to propel at least one of the at least three wheels when actuated. The shopping cart also provides a handle attached to the back of the basket. The handle has a holding portion by which the shopper holds and maneuvers the shopping cart. The handle has a switch whereby the shopper actuates the motor of the shopping cart to move the shopping cart. At such actuation, the shopping cart moves forwardly and pulls the wheelchair bound shopper also. By such action, the wheel chair bound shopper is able to shop in a store though bound to a wheelchair using said shopping cart.

### FIELD OF THE INVENTION

The invention provides a shopping system for a wheelchair bound shopper comprising a wheelchair configured for use by the shopper, wherein the shopper is at least partially bound to the wheelchair and a motorized shopping cart for pulling itself and a wheelchair bound shopper in a store. In particular, the motorized shopping cart is configured to pull itself when full with items for purchase and a wheelchair bound shopper without losing pulling power throughout the shopping trip.

### BACKGROUND OF THE INVENTION

Shopping in a retail store for the wheel chair bound can be very difficult. Such shoppers are often limited by how much they can shop. Wheel chair bound shoppers are often challenged by 1) use of a standard sized shopping cart which is not motorized, 2) their relative inability to switch from their wheelchair to a store provided motorized cart with an attached basket, and 3) their inability to acquire a full shopping load when such a user decides to remain within their wheelchair and use a carry basket which is most often situated on the lap of the shopper.

Using a non-motorized standard sized shopping cart by a wheel chair bound shopper is generally not possible or at the least provides an extremely lengthy and arduous experience. A wheel chair bound shopper using such a cart must use his own force to propel the cart throughout the store while also propelling himself in the store. Perhaps the most mobile of the wheel chair bound population can manage such an endeavor but few others can. Also, once the shopping cart becomes heavy laden with groceries, the ability to move the cart while simultaneously moving oneself becomes exponentially more difficult.

Many stores today offer a motorized cart with an attached basket thereto. However, a wheel chair bound person when using such a device must transfer, physically, from her wheelchair to the motorized device. Often, such shopper's wheelchair is expensive, ranging from the many hundreds to the many thousands of dollars. Thus, transferring away from such a wheelchair and leaving it unprotected is problematic since all such wheelchairs are mobile and therefore subject to theft.

Also, the use of the motorized cart for a wheel chair bound shopper is itself problematic. Though ambulatory, the carts themselves do not offer a full sized shopping experience. Such carts instead provide an attached cart that is generally one-half to one-third the size of a full sized standard shopping cart. And once the shopping experience is concluded, a shopper must both transfer her groceries to another vehicle and transfer herself back to her wheel chair. If the shopper is alone, that means that she must take the motorized cart to a waiting vehicle, place the groceries inside of the vehicle and then motor back to the store to then transfer her body from the motorized cart to her wheel chair. Such a process is inefficient, time-consuming, potentially dangerous and subjects her wheel chair to theft.

What is therefore needed is a shopping system for wheel chair bound persons whereby such persons can have a complete shopping experience using a full sized shopping cart. Also needed is a shopping system that enables such wheel chair bound shoppers to shop using a standard sized shopping cart. Further needed is a shopping system enabling wheel chair bound shoppers to shop efficiently without spending undue time in a retail store. The claims, figures and examples written herein provide such a shopping system for wheel chair bound shoppers.

### BRIEF DESCRIPTION OF THE INVENTION

Accordingly, the invention provides a motorized shopping cart for use by a shopper bound to a wheelchair, comprising a base. The base has a bottom side and a top side positioned oppositely to the bottom side of the base. At least three wheels are fixed to the underside of said base. A basket is attached to said top said of said base, said basket having a front, a back positioned oppositely to the front, and two sides positioned between the front and said back of the basket. A motor is attached to at least one of said at least three wheels, said motor operating to propel at least one of said at least three wheels when actuated.

A handle is attached to the back of the basket. The handle has a holding portion by which the shopper holds and maneuvers the shopping cart. The handle further comprises a switch whereby the shopper actuates the motor of the shopping cart to move the shopping cart thereby being propelled by the shopper and moving the shopper bound to the wheelchair.

Also provided is a shopping system for a wheelchair bound shopper comprising a wheelchair configured for use by the shopper, wherein the shopper is at least partially bound to the wheelchair. Also provided is a shopping cart. The shopping cart comprises a base having a bottom side and a top side positioned oppositely to the bottom side of the base. At least three wheels are fixed to the underside of said base. Further provided is a basket attached to the top side of the base. The basket has a front, a back positioned oppositely to the front, and two sides positioned between the front and the back of the basket. A motor attached to at least one of the at least three wheels, the motor operating to propel at least one of the at least three wheels when actuated. The shopping cart also provides a handle attached to the back of the basket. The handle has a holding portion by which the shopper holds and maneuvers the shopping cart. The handle has a switch whereby the shopper actuates the motor of the shopping cart to move the shopping cart. At such actuation, the shopping cart moves forwardly and pulls the wheelchair bound shopper also. By such action, the wheel chair bound shopper is able to shop in a store though bound to a wheelchair using said shopping cart.

The shopping cart herein is a standardly configured shopping cart. In such a shopping cart a shopper may place a full load of items for purchase within the full-size, standard basket of the shopping cart.

The anticipated shopper for the shopping system here is a wheelchair bound shopper that is substantially immobile from the chest down through the shopper's lower torso. Another anticipated shopper for the shopping system here is a wheelchair bound shopper that is substantially immobile from lower than the chest down (e.g., the waist). For use of the shopping system herein the shopper will have substantial use of at least one arm.

The handle of the shopping cart is configured to be within the ready grasp of the shopper. The switch on the handle of the shopping cart is readily reachable by the shopper, particularly the shopper's hand as she grasps the handle.

In practice, the motor is actuated by the switch through a connection between the switch and the motor. In one instance, the connection between the switch and the motor is wired. In another instance, the connection between the switch and the motor is wireless. The motor will substantially immediately suspend, thereby stopping all generation and transfer of propulsion power to one or more wheels of the shopping cart, if a shopper release engagement of the switch on the handle.

The shopping cart comprises at least three wheels, one or more of which may have a brake. The brake is connected to the switch by a connection. In one embodiment, the connection between the brake and the switch is wired. In another embodiment, the connection between the brake and the switch is wireless. In one instance herein, the brake decelerates the shopping cart gradually. In another instance herein, the brake decelerates the shopping cart substantially immediately or immediately.

The motor herein is configured to move the shopping cart forward and also pull the shopper in his wheel chair at the same time when actuated by the shopper. In practice, the motor is configured to propel the shopping cart when fully loaded with one or more items and pulls the shopper in his wheelchair at the same time when actuated by said shopper.

The motor herein is anticipated for heavy duty use both for fully laden, standard sized shopping carts and for a shopper an wheelchair combination totaling two hundred pounds or more. Also, the motor is configured to provide a constant rate of power to the shopping cart for moving the shopping cart and for pulling the shopper and wheel chair.

In a preferred embodiment herein, the motor is attachable to the shopping cart upon demand by the shopper. That is, the motor herein is contemplated to be attached and detached upon demand upon a standardly configured shopping cart. In such instances, the motor will itself comprise a wheel that is powered by the motor. Alternatively, the attachable motor may be used to motorize one or more of the existing shopping cart wheels.

### BRIEF DESCRIPTION OF THE DRAWINGS

While the specification concludes with claims particularly pointing out and distinctly claiming the invention, it is believed that the embodiments set forth herein will be better understood from the following description in conjunction with the accompanying figures, in which like reference numerals identify like elements and in which:

FIG. 1 provides a planar side view of a user in wheelchair being pulled by the motorized shopping car herein;

FIG. 2 provides a top view of FIG. 1;

FIG. 3 provides a side view of the motor and wheel assembly;

FIG. 4 provides a top view of FIG. 3;

FIG. 5 provides a front view of the motor and wheel assembly;

FIG. 6 provides a back view of the motor and wheel assembly of FIG. 5; and

FIG. 7 provides a top view of the motor and wheel assembly of FIG. 5.

### DETAILED DESCRIPTION OF THE SPECIFICATION

By the term “partially bound” it is meant herein a shopper's inability to be mobile, at least from the waist down, but with the ability to use his/her arms (at least substantially use one arm).

By the term “shopper” it is meant herein a shopper bound to a wheel chair that is unable to move in an upright self-ambulatory manner.

By the term “standardly configured” or “standard sized shopping cart” it is meant herein a shopping cart of standard size, design, construction and weight to all other grocery/retail based shopping carts in the United States.

By there term “full load” it is meant herein the same load of items placeable within a non-motorized standard sized shopping cart.

By the term “store” it is meant herein a retail store, a warehouse, a factory, a stadium, a machine shop, an office building, and the like.

A shopping system for a wheelchair bound shopper comprising a wheelchair configured for use by the shopper, wherein the shopper is at least partially bound to the wheelchair. Also provided is a shopping cart. The shopping cart comprises a base having a bottom side and a top side positioned oppositely to the bottom side of the base. At least three wheels are fixed to the underside of said base. Further provided is a basket attached to the top side of the base. The basket has a front, a back positioned oppositely to the front, and two sides positioned between the front and the back of the basket. A motor attached to at least one of the at least three wheels, the motor operating to propel at least one of the at least three wheels when actuated. The shopping cart also provides a handle attached to the back of the basket. The handle has a holding portion by which the shopper holds and maneuvers the shopping cart. The handle has a switch whereby the shopper actuates the motor of the shopping cart to move the shopping cart. At such actuation, the shopping cart moves forwardly and pulls the wheelchair bound shopper also. By such action, the wheel chair bound shopper is able to shop in a store though bound to a wheelchair using said shopping cart.

The shopping cart herein is a standardly configured shopping cart. In such a shopping cart a shopper may place a full load of items for purchase within the full-size, standard basket of the shopping cart.

The anticipated shopper for the shopping system here is a wheelchair bound shopper that is substantially immobile from the chest down through the shopper's lower torso. Another anticipated shopper for the shopping system here is a wheelchair bound shopper that is substantially immobile from lower than the chest down (e.g., the waist). For use of the shopping system herein the shopper will have substantial use of at least one arm.

The handle of the shopping cart is configured to be within the ready grasp of the shopper. The switch on the handle of the shopping cart is readily reachable by the shopper, particularly the shopper's hand as she grasps the handle.

In practice, the motor is actuated by the switch through a connection between the switch and the motor. In one instance, the connection between the switch and the motor is wired. In another instance, the connection between the switch and the motor is wireless. The motor will substantially immediately suspend, thereby stopping all generation and transfer of propulsion power to one or more wheels of the shopping cart, if a shopper release engagement of the switch on the handle.

The shopping cart comprises at least three wheels, one or more of which may have a brake. The brake is connected to the switch by a connection. In one embodiment, the connection between the brake and the switch is wired. In another embodiment, the connection between the brake and the switch is wireless. In one instance herein, the brake decelerates the shopping cart gradually. In another instance herein, the brake decelerates the shopping cart substantially immediately or immediately.

The motor herein is configured to move the shopping cart forward and also pull the shopper in his wheel chair at the same time when actuated by the shopper. In practice, the motor is configured to propel the shopping cart when fully loaded with one or more items and pulls the shopper in his wheelchair at the same time when actuated by said shopper.

The motor herein is anticipated for heavy duty use both for fully laden, standard sized shopping carts and for a shopper an wheelchair combination totaling two hundred pounds or more. Also, the motor is configured to provide a constant rate of power to the shopping cart for moving the shopping cart and for pulling the shopper and wheel chair.

In a preferred embodiment herein, the motor is attachable to the shopping cart upon demand by the shopper. That is, the motor herein is contemplated to be attached and detached upon demand upon a standardly configured shopping cart. In such instances, the motor will itself comprise a wheel that is powered by the motor. Alternatively, the attachable motor may be used to motorize one or more of the existing shopping cart wheels.

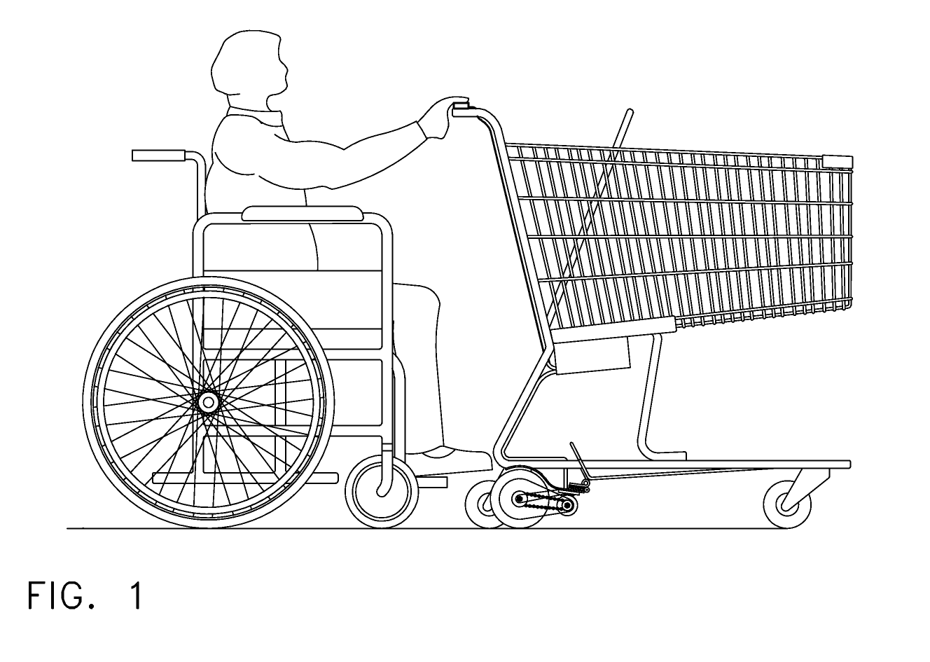

FIG. 1 provides a planar side view of a wheelchair bound shopper or shopper 5 in his wheelchair 10. Shopper 5 is being pulled in wheelchair 10 by shopping cart 20. As shown, shopper's hand grasps handle 22 and more particularly switch 28 positioned onto handle 22. FIG. 1 shows only one of shopper's hand grasping handle 22, but shopper 5 is well able to hold and grasp handle 22 with both hands.

Shopping cart 20 herein is preferably a standard sized shopping cart found in most retail outlets in the United States and particularly in grocery stores. Shopping cart 20 contains a standard sized basket or basket 22 that is built to hold a full load of groceries in a typical grocery shopping trip. Typically, basket 22 sits upon a base 24 that serves as a frame to which basket 22 is attached and also to which two or more shopping cart wheels or wheels 25 are attached. Handle 26 is attached to the back upper portion of the frame of base 24 as shown in FIG. 1.

When shopper 5 actuates switch 28, shopping cart 20 moves and pulls shopper 5 and wheelchair 10 forward. In one embodiment herein, switch 28, when de-activated by shopper 5, causes shopping cart 20 to come to an immediate halt. This happens because switch 28 contains a ‘kill switch’ 29 (not shown) that immediately cuts power transference from motor 50 to any of the shopping cart wheels or wheels 25. Alternatively, when switch 28 is de-activated, a brake 30 in one or more wheels 25 is actuated which serve either solely to immediately stop shopping cart 20 or work in conjunction with kill switch 29 to immediately stop shopping cart 20. By the term ‘kill switch’ it is meant herein mechanism used to immediately shut off motor 50 when switch 28 is no longer actuated by shopper 5.

In another embodiment herein, de-activation of switch 28 causes shopping cart 20 to stop gradually. In this embodiment either of the following or a combination thereof occurs: 1) switch 28 gradually reduces power transference from motor 50 to one or more wheels 25 thereby using the weight of the cart, its load (if any), and friction from the floor surface to reduce the shopping cart's momentum thereby slowing it to an eventual halt or 2) switch 28 immediately cuts power transference from motor 50 to one or more wheels 25 and brake 30 actuates to gradually reduce the momentum of shopping cart 20 thereby slowing and gradually stopping shopping cart 20.

Switch 28 is preferably connected to motor 50 by one or more wired connections 40. Typically, wires 42 of wired connection 40 are attached on one end to switch 28 and extend from handle 26 to motor 50 that is attached to base 24.

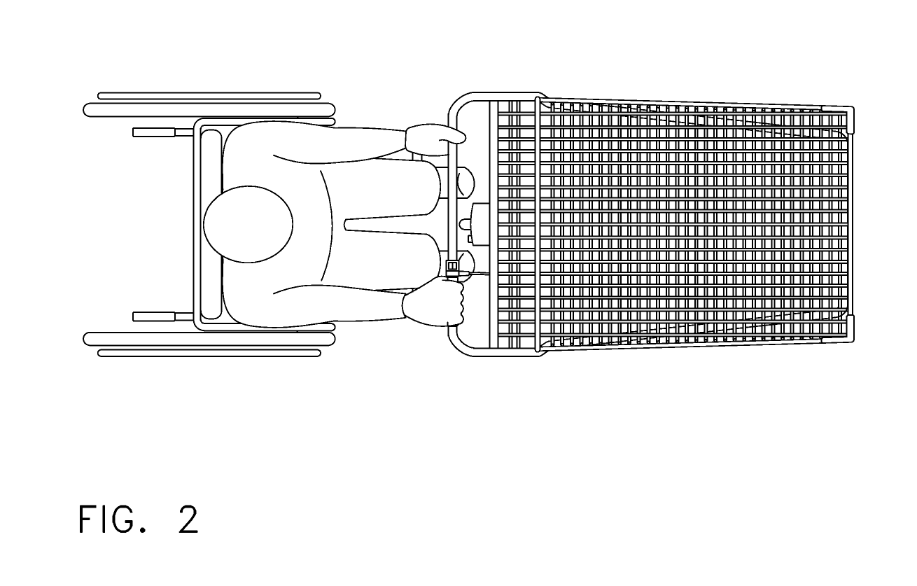

FIG. 2 provides a top view of FIG. 1. Shopper 5, as shown, as one or two arms extended to handle 26 of shopping cart 20. If shopper 5 has only one hand extended, it is the hand connected to the arm closest to switch 28 for the operation of shopping cart 20. As shown, switch 28 is on the right side or end of handle 26. Placement of switch 28 is arbitrary, however, and can be placed in a location on handle 26 that is most convenient for shopper 5. For example, if shopper 5 is left hand dominant, switch 28 may be adjusted to be positioned on the left end of handle 26. Placement of switch 28 on handle 26 forms no part of the invention herein.

FIG. 4 provides a top view of motor 50 attached to a partial section of base 24. As shown, motor 50 is attached to the underside of base 24, i.e., the side of base 24 directly facing the horizontal surface (e.g., a floor) upon which shopping cart 20 stands. Motor 50 may be fixedly attached to base 24 through one or more attachment devices like screws, brackets, clips and the like. By “fixedly attached” it is meant herein that motor 50 attachment to base 24 is meant to be permanent or substantially permanent, thus forgoing an ease of detachment of motor 50 from base 24.

Alternatively, motor 50 may be releasably attached to base 24. By “releasably attached” it is meant herein that while motor 50 is attached to the underside of base 24, it is attached in a releasable manner that allows an operator (e.g., a store employee) to detach motor 50 from shopping cart 24 thereby altering shopping cart 24 from motorized to non-motorized.

Motor assembly 50 may also be fully integrated into base 24 whereby it is built into shopping cart 20. In this embodiment, shopping cart 20 remains motorized and is not detachable from base 24.

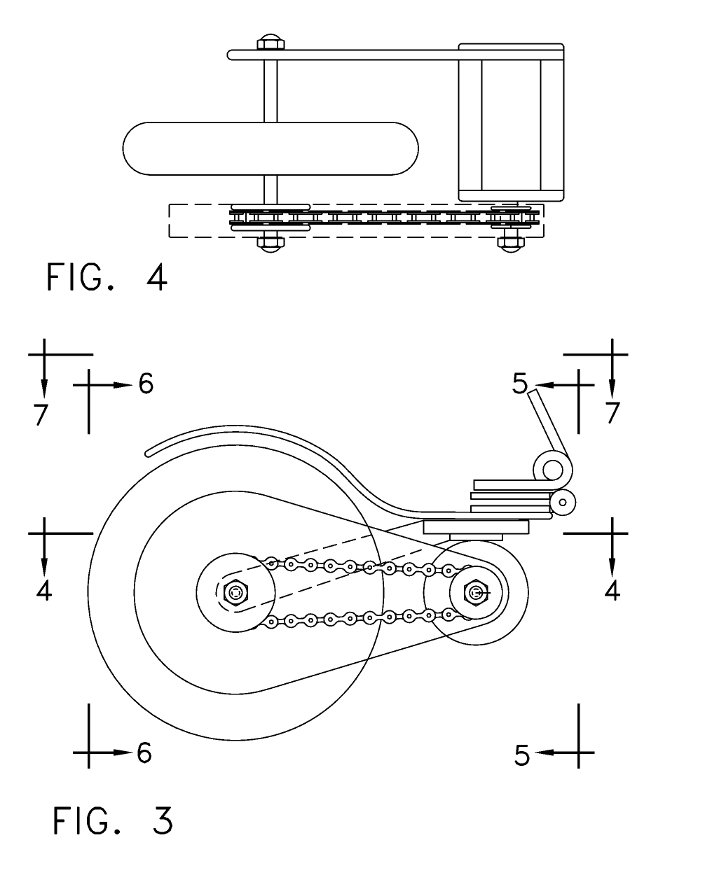

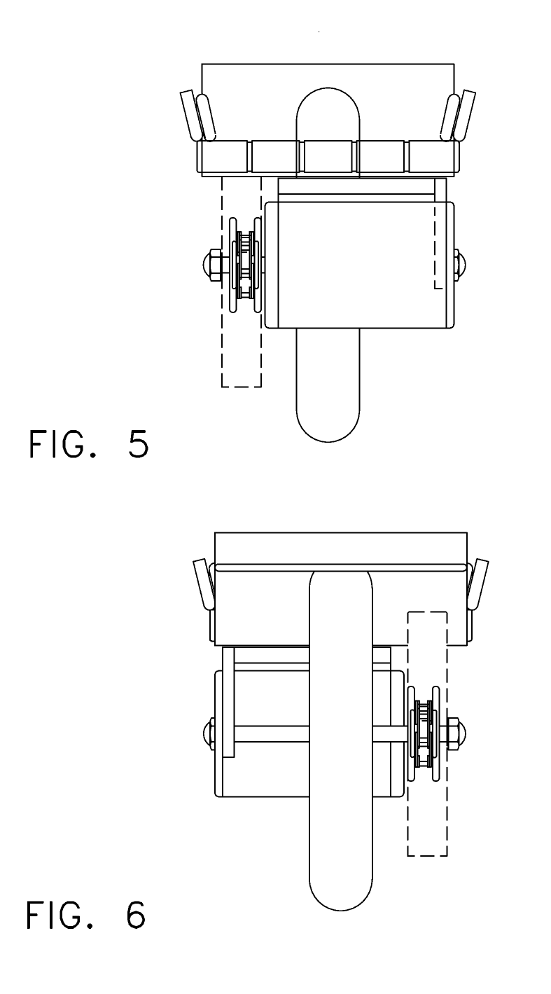

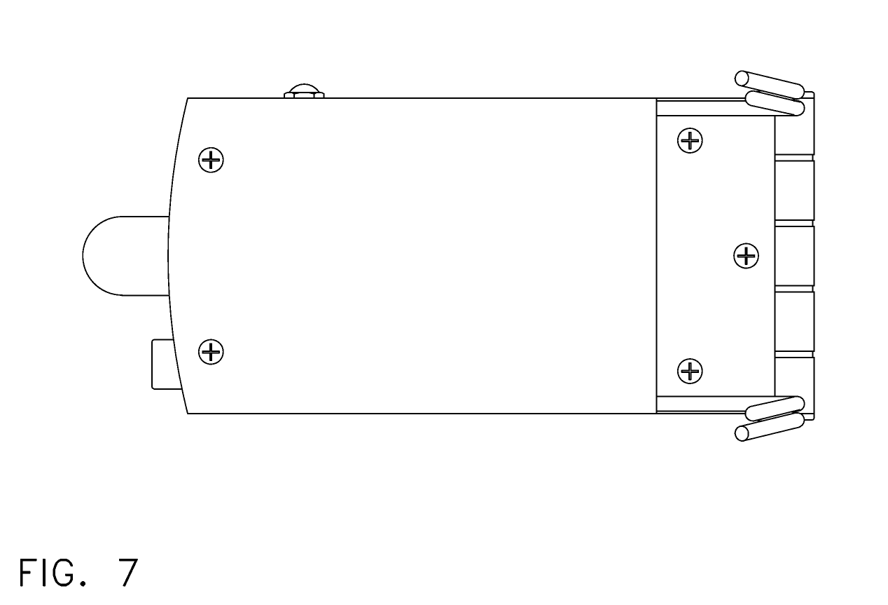

FIG. 3 provides a side view of motor assembly 50. Motor assembly 50 comprises two main elements motor 52 and drive wheel 54. Motor 52 is positioned within motor assembly 50. Motor 52 is preferably an electric motor and is thereby powered using one or more batteries that are preferably, but not necessarily, rechargeable. A drive shaft 53 (not shown) is attached to motor 52 and extends therefrom. Drive wheel 54 has a center through which drive shaft 53 extends and is connected to drive wheel 54. In practice, drive shaft 53 is driven by motor 52 that in turn drives drive wheel 54.

As shown, drive wheel 54 protrudes from the underside of motor assembly 50, which is the side closest to the surface of contact, i.e., the floor. At least a portion of drive wheel 54 is hidden or enclosed within motor assembly 50. The remaining portion of drive wheel 54 thus shows outside of motor assembly 50.

Motor assembly 50 is spring hinged. Such configuration causes a downward force to be applied upon drive wheel 54. This downwardly applied force ensures that drive wheel 54 evenly applies traction to a surface even if the surface deviates from a substantially level surface.

As noted hereinbefore, power for motor assembly 50 is preferably generated by an electric motor—motor 52. Such an electric motor preferably comprises a 24 volt power output system coupled with a 100-200 Watt motor. The wattage of the motor depends upon the power generated by the motor, whether 12 volts or 24 volts. Motor 54 is preferably powered by one or more batteries 60 (not shown) of the kind well known by persons of skill in the art for powering electric motors; e.g., ion-lithium; alkaline (including rechargeable); lithium nickel-zinc, and the like. In the preferred 24 volt motor herein, the number of batteries, if greater than one, combine to produce 24 volts of power, at least, to allow for the 24 volt output desired.

Power from batteries 60 is delivered to motor 54 through an electronic speed controller. Motor 54 comprises a spur gear (not shown) positioned onto drive shaft 53. Delivering the power to the larger gear attached to the drive wheel with a chain. Much like common one-speed bicycle. Gear-chain-gear.

Also provided is handle 26 and throttle switch 28 combination located on shopping cart 20. Throttle switch 28 comprises a handle grip potentiometer similar to those known in the art for motorcycles, scooters and the like. Throttle switch 28 also preferably comprises an automatic cut-off that suspends the transfer of electric power from motor 52 through drive shaft 53. At such suspension, shopping cart 20 will either gradually stop under its own weight and friction from the wheels 25 and rolling surface or it will stop substantially immediately. If substantially immediately, shopping cart 20 may stop substantially immediately due to friction in wheels 25. Alternatively, brake assembly 30 (not shown) may be attached to one or more wheels 25.

Brake assembly 30 is attached to throttle switch 28. Such attachment may either be hard wired or wireless. If wireless, brake assembly 30 and throttle switch 28 are connected, preferably, by a BLUETOOTH® connection of the kind well known by those of skill in the art. Brake assembly 30 is attached to at least one wheel 25 and comprises a dampening device 32 (not shown) positioned on the inner surface, preferably, of wheel 25, dampening device 32 being actuated against wheel 25 at an operator's release of throttle switch 28.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A motorized shopping cart for use by a shopper bound to a wheelchair, comprising:
a. A base, said base having a bottom side and a top side positioned oppositely to said bottom side of said base;
b. At least three wheels fixed to said underside of said base;
c. A basket attached to said top said of said base, said basket having a front, a back positioned oppositely to said front, and two sides positioned between said front and said back of said basket;
d. A motor attached to at least one of said at least three wheels, said motor operating to propel at least one of said at least three wheels when actuated; and
e. A handle attached to said back of said basket, said handle having
i. A holding portion by which said shopper holds and maneuvers said shopping cart; and
ii. A switch whereby said shopper actuates said motor of said shopping cart to move said shopping cart thereby being propelled by said shopper and moving said shopper bound to said wheelchair.

2. The motorized shopping cart of claim 1 herein wherein said shopping cart is a standardly configured shopping cart.

3. The motorized shopping cart of claim 2 wherein said shopper may place a full load of items within said basket of said shopping cart.

4. The motorized shopping cart of claim 1 wherein said shopper is substantially immobile from the waist down through said shopper's lower torso.

5. The motorized shopping cart of claim 4 whereby said shopper has substantial use of at least one arm.

6. The motorized shopping cart of claim 1 wherein said handle and said switch of said shopping cart are configured to be within ready grasp of said shopper.

7. The motorized shopping cart of claim 6 wherein said motor is actuated by said switch through a connection between said switch and said motor.

8. The motorized shopping cart of claim 7 wherein said connection between said switch and said motor is wired.

9. The motorized shopping cart of claim 7 wherein said connection between said switch and said motor is wireless.

10. The motorized shopping cart of claim 7 wherein said motor substantially immediately stops propelling said shopping cart at release of said switch.

11. The motorized shopping cart of claim 7 wherein at least one of said at least three wheels comprises a brake, said brake being connected to said switch by a connection.

12. The motorized shopping cart of claim 11 wherein said connection between said brake and said switch is wired.

13. The motorized shopping cart of claim 11 wherein said connection between said brake and said switch is wireless.

14. The motorized shopping cart of claim 11 wherein said brake decelerates said shopping cart gradually.

15. The motorized shopping cart of claim 11 wherein said brake decelerates said shopping cart substantially immediately.

16. The motorized shopping cart of claim 1 wherein said motor is configured to propel said shopping cart and pulls said shopper in said wheel chair at the same time when actuated by said shopper.

17. The motorized shopping cart of claim 16 wherein said motor is configured to propel said shopping cart when fully loaded with one or more items and pulls said shopper in said wheel chair at the same time when actuated by said shopper.

18. The motorized shopping cart of claim 17 wherein said motor is configured to provide a constant rate of power to said shopping cart for propelling said shopping cart and for pulling said shopper bound to said wheel chair.

19. The motorized shopping cart of claim 1 wherein said motor is attachable and detachable to said shopping cart upon demand by said shopper.

20. The motorized shopping cart of claim 19 wherein said motor comprises a motor and at least one wheel whereby said motor powers said at least one wheel when said motor is actuated by a shopper.
